(19) United States
(12) Patent Application Publication
(10) Pub. No.: US 2008/0099409 A1
(43) Pub. Date: May 1, 2008

(54) Swimming pool robot

(75) Inventors: Boris Gorelik, Kiryat-Ata (IL); Tzachi Shpitzer, Haifa (IL); Amir Yakobovitch, Haifa (IL)

Correspondence Address: DARBY & DARBY P.C., P.O. BOX 770, Church Street Station, New York, NY, 10008-0770, US

(73) Assignee: Aquatron Robotic Systems LTD., Afula Illit (IL)

(21) Appl. No.: 11/588,510

(22) Filed: Oct. 26, 2006

(51) Int. Cl. B01D 35/26

(52) U.S. Cl. 210/780; 210/416.2

(57) ABSTRACT

Cleaning apparatus includes a housing, which includes a lower side comprising an opening, and an upper side including an egress port and a lid, which opens to provide access to an interior of the housing. An impeller is disposed within the housing so as to draw water into the housing through the opening and to expel the water through the egress port. A filter assembly is contained within the housing and is of a size and shape suitable for removal from the housing via the lid. The filter assembly includes separable upper and lower segments having a wall that includes a filter material. The lower segment has an ingress port that communicates with the ingress port so that the water drawn in through the opening enters the filter assembly through the ingress port and exits the filter assembly through the filter material.

### FIELD OF THE INVENTION

The present invention relates generally to underwater cleaning devices, and specifically to devices for cleaning the inner surfaces of a swimming pool or other liquid container.

### BACKGROUND OF THE INVENTION

A variety of devices are known in the art for automated cleaning of swimming pools. Some of these devices comprise wheels or treads with an internal propulsion system, so that the device travels autonomously along the floor (and sometimes the walls) of the swimming pool, while sucking contaminants from the floor (and walls) into an internal filter element. Devices of this sort are referred to commonly as “robots.” Removal and cleaning of the filter element can be a difficult and time-consuming job. A number of patents describe filter arrangements that are supposed to make the job easier.

For example, U.S. Pat. No. 6,409,916, whose disclosure is incorporated herein by reference, describes a filter element for a pool-cleaning device. The pool-cleaning device itself comprises an outer shell with a detachable lid and an inner shell, which is open at its upper end and accommodates an impeller and a clean-water exit tube. The filter element has a basket-like shape including a tubular central stem configured to be seated on the exit tube. The central stem is surrounded by an annular trough, which constitutes the active filtering portion of the filter element. During operation of the device, solids-entraining water drawn by the impeller enters the annular trough from above and, passing the active filtering portion, emerges as clean water to be expelled through the exit tube and returned to the pool. The filter element may be removed for cleaning or replacement by opening the lid.

As another example, U.S. Pat. No. 6,473,927, whose disclosure is incorporated herein by reference, describes a swimming pool cleaning device in which the filter can be exchanged and contamination-exposed parts can be cleaned without it being necessary to raise or tilt the device. This cleaning device comprises a housing and at least one intake aperture at the base of the housing. A liquid to be cleaned is conveyed by a pump into an inner chamber within the housing and via a filter to an outlet aperture. The filter separates a contamination-exposed part from a clean part of the inner chamber. For cleaning, the cover of the device is removed, and the filter is withdrawn vertically upward.

### SUMMARY OF THE INVENTION

Embodiments of the present invention provide devices and methods for underwater cleaning, which are designed for ease in removal and cleaning of the contaminant-capturing filter assembly.

There is therefore provided, in accordance with an embodiment of the present invention, cleaning apparatus, including:

a housing, which includes a lower side including an opening, and an upper side including an egress port and a lid, which opens to provide access to an interior of the housing;

an impeller, which is disposed within the housing so as to draw water into the housing through the opening and to expel the water through the egress port; and

a filter assembly, which is contained within the housing and is of a size and shape suitable for removal from the housing via the lid, the filter assembly including separable upper and lower segments having a wall that includes a filter material, the lower segment having an ingress port that communicates with the ingress port so that the water drawn in through the opening enters the filter assembly through the ingress port and exits the filter assembly through the filter material.

In some embodiments, the filter assembly includes a quick-connect mechanism for holding the upper and lower segments together during operation of the apparatus, whereby contaminants in the water are trapped inside the filter assembly, and for permitting the upper and lower segments to be separated so as to enable an operator to clean the trapped contaminants out of the filter assembly after opening the lid and removing the filter assembly from the housing. In one embodiment, the quick-connect mechanism includes a hinge.

In a disclose embodiment, the lower side of the housing includes a plurality of openings, and the filter assembly includes a plurality of filter assemblies, having respective ingress ports, each of which communicates respectively with one of the openings. The filter assembly may include a frame, to which the filter material is attached.

There is also provided, in accordance with an embodiment of the present invention, cleaning apparatus, including:

a housing, which includes an upper side including an egress port and has an open lower side;

an impeller, which is disposed within the housing so as to draw water into the housing through the lower side and to expel the water through the egress port; and

a filter assembly, which includes:
a cover, which includes an ingress port, and which has inner and outer sides and is configured to engage and close the open lower side of the housing;
a frame, which includes a base, which is fixed to the inner side of the cover, and an upper end, which protrudes from the base into an interior of the housing;
a rim, which is sized and shaped to contact the inner side of the cover along a perimeter surrounding the base of the frame; and
a filter including a flexible filter material, which has a peripheral edge that is fixed to the rim so that the filter material covers the frame when the rim is in place along the perimeter on the inner side of the cover so that the water drawn in by the impeller enters the filter assembly through the ingress port and exits the filter assembly through the filter material,
wherein the filter material is attached to the upper end of the frame at one or more attachment points.

In some embodiments, the apparatus includes a catch for holding the cover against the lower side of the housing during operation of the apparatus, whereby contaminants in the water are trapped inside the filter assembly, and for permitting the filter assembly to be removed from the housing so as to enable an operator to turn the filter inside-out for removal of the contaminants by pulling the rim away from the cover and over the upper end of the frame after releasing the catch and removing the filter assembly from the housing. Optionally, the apparatus includes a handle, which is attached to the rim so as to enable the operator to pull the rim away from the cover and turn the filter inside-out by pulling the handle.

There is additionally provided, in accordance with an embodiment of the present invention, a method for cleaning, including:

submerging a robot at a bottom of a container of water, the robot containing a filter assembly, which includes upper and lower segments having a wall that includes a filter material, the lower segment having an ingress port at a lower side of the robot in communication with the bottom of the container;

operating the submerged robot to draw water in through the ingress port so that the water enters an interior of the filter assembly through the ingress port and exits the filter assembly through the filter material;

following operation of the robot, opening an upper side of the robot, and removing the filter assembly from the robot through the upper side; and

after removing the filter assembly from the robot, separating the upper and lower segments of the filter assembly in order to remove contaminants trapped in the interior of the filter assembly.

There is further provided, in accordance with an embodiment of the present invention, a method for cleaning, including:

submerging a robot at a bottom of a container of water, the robot containing a filter assembly, which has an ingress port at a lower side of the robot in communication with the bottom of the container and which includes a lower cover containing the ingress port, a frame having a base that is attached to the lower cover, and a filter material attached to the frame and having a peripheral edge that surrounds the base;

operating the submerged robot to draw water in through the opening so that the water enters an interior of the filter assembly through the ingress port and exits the filter assembly through the filter material;

following operation of the robot, removing the filter assembly from the robot; and

after removing the filter assembly from the robot, turning the filter material inside-out in order to remove contaminants trapped in the interior of the filter assembly while the filter material remains attached to the frame.

In a disclosed embodiment, the peripheral edge of the filter material is fixed to a rim, which is sized and shaped to contact an inner side of the cover along a perimeter surrounding the base of the frame, and turning the filter material inside-out includes pulling the rim away from the cover and over an upper end of the frame.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a robot with an enhanced filter assembly for cleaning a swimming pool, in accordance with an embodiment of the present invention;

FIGS. 2-5 are schematic, pictorial illustrations showing successive steps in removal and cleaning of the filter assembly from the robot of FIG. 1, in accordance with an embodiment of the present invention;

FIG. 6 is a schematic, pictorial illustration of a robot for cleaning a swimming pool, in accordance with another embodiment of the present invention;

FIG. 7 is a schematic, sectional illustration of the robot of FIG. 6;

FIGS. 8A and 8B are schematic, sectional views of a filter assembly for use in the robot of FIG. 6, in open and closed configurations of the filter assembly, in accordance with an embodiment of the present invention; and

FIGS. 9-11 are schematic, pictorial illustrations showing successive steps in removal and cleaning of the filter assembly from the robot of FIG. 6, in accordance with an embodiment of the present invention.

### DETAILED DESCRIPTION OF EMBODIMENTS

### Bottom-Opening Robot

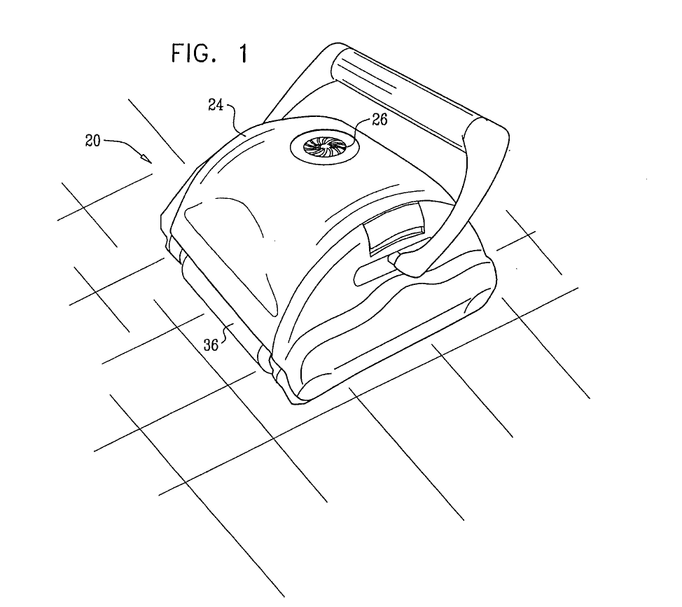

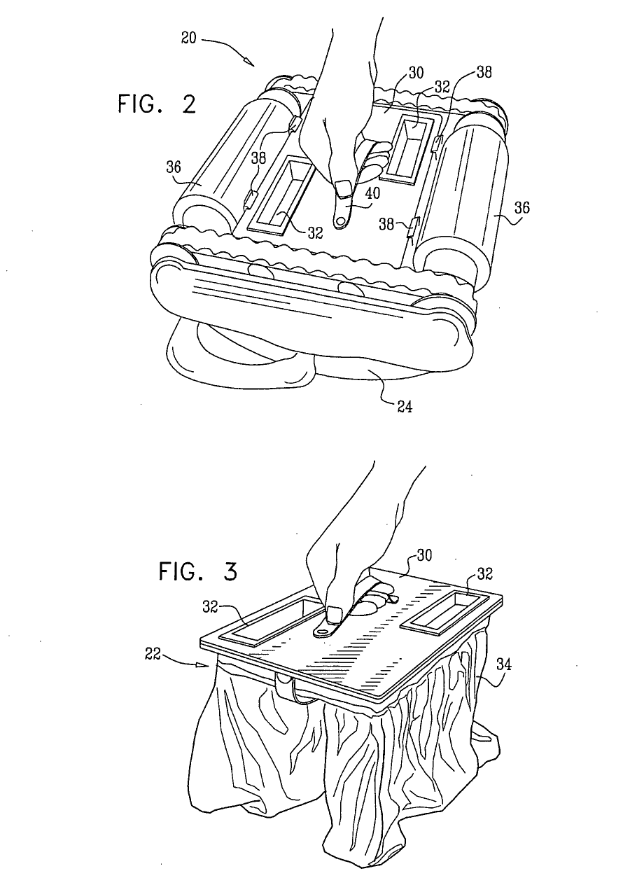

Reference is now made to FIGS. 1-3, which are schematic, pictorial illustrations of a robot 20 for cleaning the interior of a swimming pool or other liquid container, and of a filter assembly 22 used in the robot, in accordance with an embodiment of the present invention. FIG. 1 is a top view of the robot in its normal, upright operating configuration. FIG. 2 is a bottom view of the robot, which has been inverted for removal of the filter assembly, which is itself shown in FIG. 3.

Robot 20 comprises a housing 24, which contains filter assembly 22 and an impeller (not shown in these figures). The upper side of the housing comprises an egress port 26. The lower side of the housing is open. Filter assembly 22 comprises a cover 30, which closes the open lower side of the housing. Cover 30 comprises one or more ingress ports 32. In normal operation of the robot, the impeller draws water in from the bottom of the swimming pool through ports 32, into the interior of the filter assembly. The water passes through a filter 34 and out through egress port 26, while contaminants in the water are trapped inside the filter. The filter comprises a suitable, flexible filter material, such as a dense-weave cloth or porous synthetic. Typically, the robot comprises wheels 36, which are driven by a motor (not shown in these figures) inside housing 24 to propel the robot along the bottom of the swimming pool.

Periodically, it is necessary to clean out the accumulated contaminants from the inside of filter assembly 22. For this purpose, an operator removes the robot from the water and inverts the robot, as shown in FIG. 2. The operator then releases catches 38, which hold cover 30 against the open lower side of housing 24 and pulls on an outer handle 40 in order to remove the filter assembly from the housing. (Although a particular type of clips are used as catches 38 in the pictured embodiment, the catches may alternative comprise substantially any suitable type of fasteners.) FIG. 3 shows the filter assembly as it appears after removal from the housing (or before re-insertion into the housing after cleaning.

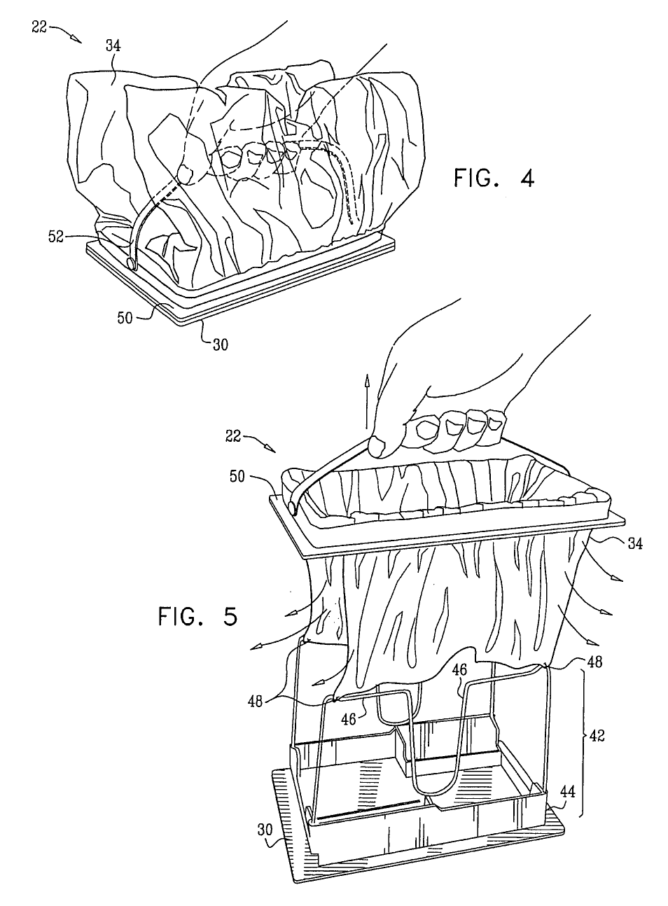

FIGS. 4 and 5 are schematic, pictorial illustrations showing successive steps in a process of cleaning filter assembly 22, in accordance with an embodiment of the present invention. As can be seen in FIG. 5, the filter assembly comprises a frame 42, having a base 44 that is fixed to the inner side of cover 30. Upper ends 46 of the frame protrude into the interior of housing 24 when the filter assembly is inserted in the housing. Filter 34 is attached at a number of attachment points 48 to the upper ends of the frame. The peripheral edge of the filter is fixed to a rim 50, which is sized and shaped to contact the inner side of cover 30 along a perimeter surrounding base 44, as shown in FIG. 4. In the normal operating configuration of robot 20, rim 50 is fixed in place, flush against the inner side of cover 30 around base 44. The rim may be held in place by a suitable quick-connect mechanism (not shown), or it may be held simply by virtue of fitting snugly around base 44. Rim 50 and/or base 44 may comprise flexible, resilient materials (such as a flexible plastic or metal) and may be shaped so as to enhance the snug fit.

To clean filter assembly 22, the operator grasps an inner handle 52, which is attached to rim 50, as shown in FIG. 4. The operator then pulls handle 52 away from cover 30, thus lifting rim 50 up and over upper ends 46 of frame 42. Filter 34, however, remains attached to the frame at attachment points 48. Therefore, at full extension of rim 50 away from cover 30, filter 34 is turned inside-out, as shown in FIG. 5. In this configuration, the contaminants that were trapped inside the filter can now be washed off easily, by directing a stream of water at the filter, for example. Optionally, filter assembly may comprise a mechanism, such as one or more struts (not shown), that holds rim 50 and cover 34 apart in the configuration shown in FIG. 5 during cleaning. When cleaning is completed, the operator simply pushes rim 50 back down around frame 42 to the position shown in FIG. 4, and then reassembles the filter assembly into housing 24.

Thus, the novel design of filter assembly 22 simplifies and speeds the cleaning process. By contrast, in bottom-opening robot designs that are known in the art, the operator must typically remove the filter material completely from the frame before cleaning, and then reassemble the filter material on the frame thereafter. Although the elements of filter assembly 22, such as cover 30, frame 42 and rim 50, are shown in the figures as having certain particular shapes and relative sizes, the principles of the present embodiment may be implemented in elements of different shapes and sizes that permit the filter to be inverted for cleaning without detaching the filter material from the other elements of the filter assembly. All such alternative designs are considered to be within the scope of the present invention.

### Top-Opening Robot

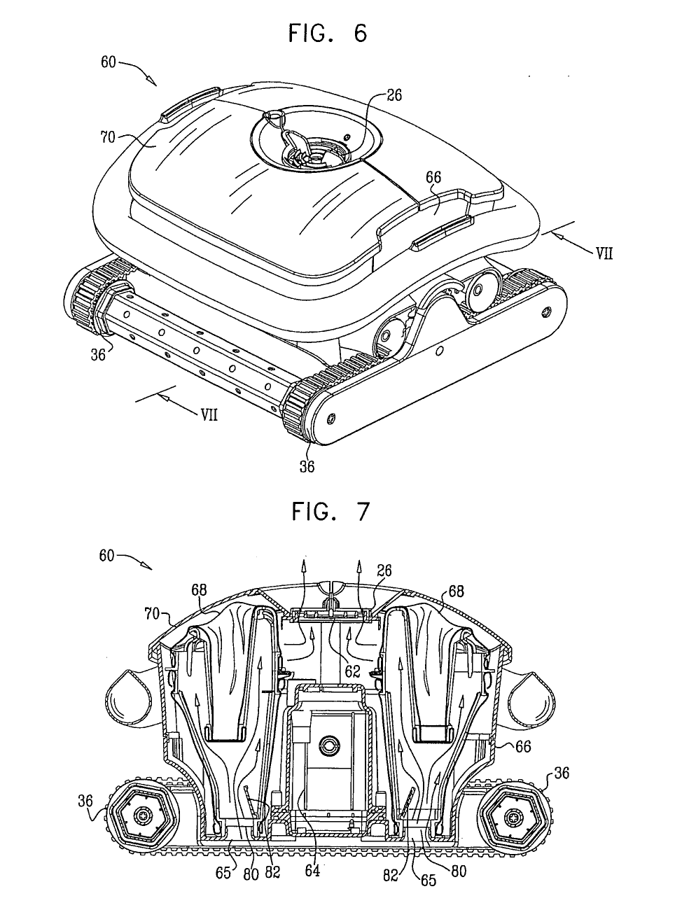

Reference is now made to FIGS. 6 and 7, which schematically illustrate a robot 60, in accordance with another embodiment of the present invention. FIG. 6 is a pictorial illustration, showing the robot from the top, while FIG. 7 is a sectional illustration, taken along a line VII-VII in FIG. 6. The basic principle of operation of robot 60 is similar to that of robot 20: An impeller 62, driven by a motor 64, draws water in through openings 65 in the lower side of a housing 66, and expels the water through egress port 26 in the upper side. The water passes through one or more filter assemblies 68 inside housing 66, whereupon contaminants in the water are trapped inside the filter assemblies. Although the impeller is shown in these figures in a certain location and configuration, impellers of other sorts, and/or in other locations in the robot, may be used for the same purpose of moving water through the filter assemblies. The term “impeller,” as used in the present patent application and in the claims, should thus be understood broadly as referring to any suitable sort of water-moving mechanism, including various types of pumps and propellers as are known in the art. Wheels 36 propel robot 60 across the bottom of the swimming pool.

Robot 60 differs from robot 20 in the design of the filter assemblies and in the method used to remove and clean them. Robot 60 comprises a lid 70 on the upper side of housing 66. Filter assemblies 68 are removed from the robot for cleaning by opening lid 70 and pulling the filter assemblies upward and out of the housing. There is no need to turn the robot upside down and remove the bottom of the housing as in the preceding embodiment. (Optionally, however, robot 60 may have a separate side or bottom cover to provide access to other parts of the interior of the housing.) Details of the procedure for cleaning the filter assemblies in robot 60, as well as of the novel construction of filter assemblies 68, are described hereinbelow.

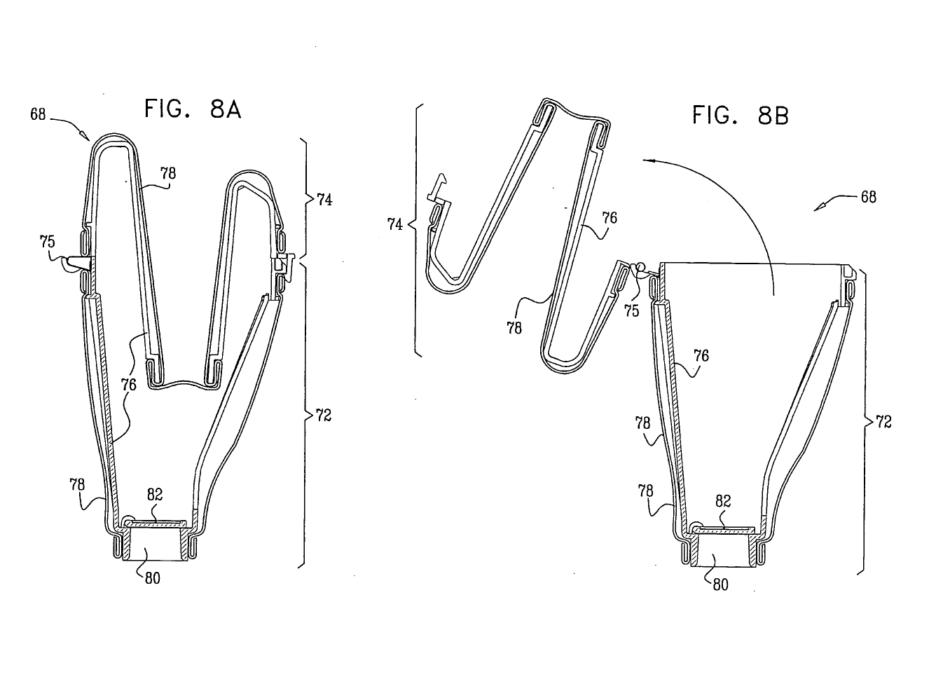

FIGS. 8A and 8B are schematic, sectional illustrations of one of filter assemblies 68, in closed and open configurations, respectively, in accordance with an embodiment of the present invention. Assembly 68 comprises lower and upper segments 72 and 74. In normal operation, these segments are attached together as shown in FIG. 8A. The segments may be separated from one another for cleaning as shown in FIG. 8B. In the embodiment shown in the figures, the upper and lower segments are attached by a hinge 75, which facilitates opening and closing, but any other suitable sort of quick-connect fastening may be used to connect and separate the segments as necessary.

Assembly 68 comprises a frame 76, which is covered by or lined with a filter material 78. The frame may comprise any suitable rigid or semi-rigid material, such as a metal or plastic, which is formed in the desired shape to define the walls of the filter assembly, and is equipped with hinge 75 and/or other hardware for opening and closing the assembly. Filter material 78, as in the preceding embodiment, may typically comprise cloth or porous synthetic material.

Lower segment 72 comprises an ingress port 80, which communicates with opening 65 when filter assembly 68 is assembled inside housing 66. Thus, during operation of robot 60, the water that is drawn into the opening by the action of impeller 62 passes into the interior of the filter assembly via ingress port 80. When impeller 62 is not in operation, an optional door 82 closes off ingress port 80 (typically by action of gravity or spring loading) to prevent contaminants from flowing back out of the filter assembly and into the swimming pool. Door 82 opens to admit water into the filter assembly under the force of the inward water pressure that is created when the impeller is in operation.

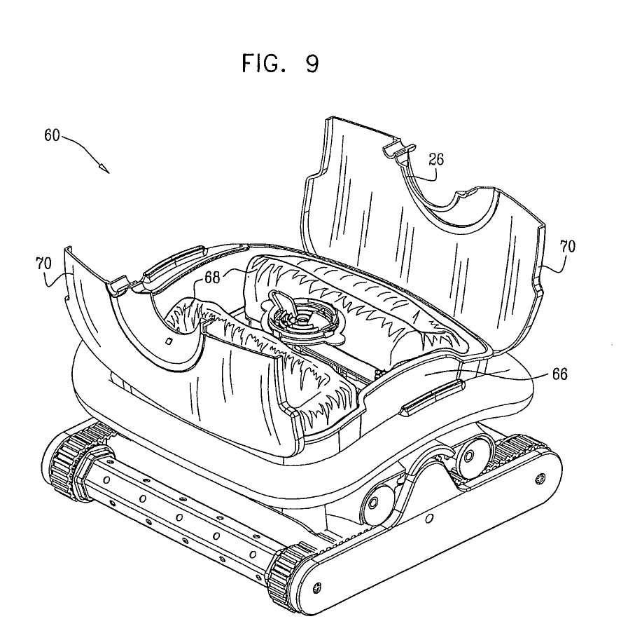

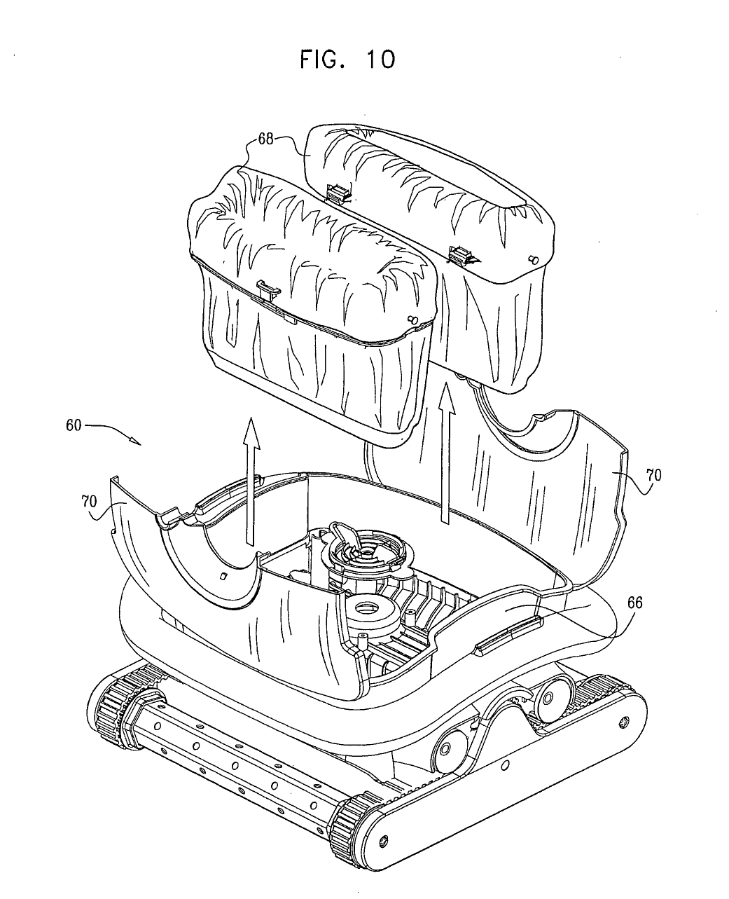

Reference is now made to FIGS. 9-11, which are schematic, pictorial illustrations showing steps in a process of cleaning filter assemblies 68 in robot 60, in accordance with an embodiment of the present invention. To clean the filter assemblies, an operator removes robot 60 from the swimming pool and opens lid 70, as shown in FIG. 9. The size and shape of the filter assemblies is such that when the lid is opened, the filter assemblies may be removed upward through the open lid, as shown in FIG. 10. Although the figures show robot 60 as comprising two filter assemblies of a particular size and shape, in alternative embodiments (not shown in the figures), the robot may comprise only a single filter assembly or may comprise three or more such filter assemblies of any suitable size and shape. In any case, the filter assemblies are configured to receive water drawn into the robot through an opening at their lower end, to capture contaminants inside the filter assembly, and then to be removed upward for cleaning through the upper side of the robot. The lid that is opened to permit removal of the filter assemblies from the robot may comprise a pair of hinged doors, as shown in FIGS. 9 and 10, or it may alternatively comprise one or more lid pieces that may be lifted off housing 66, folded or slid aside, or opened in any other suitable fashion that is known in the art.

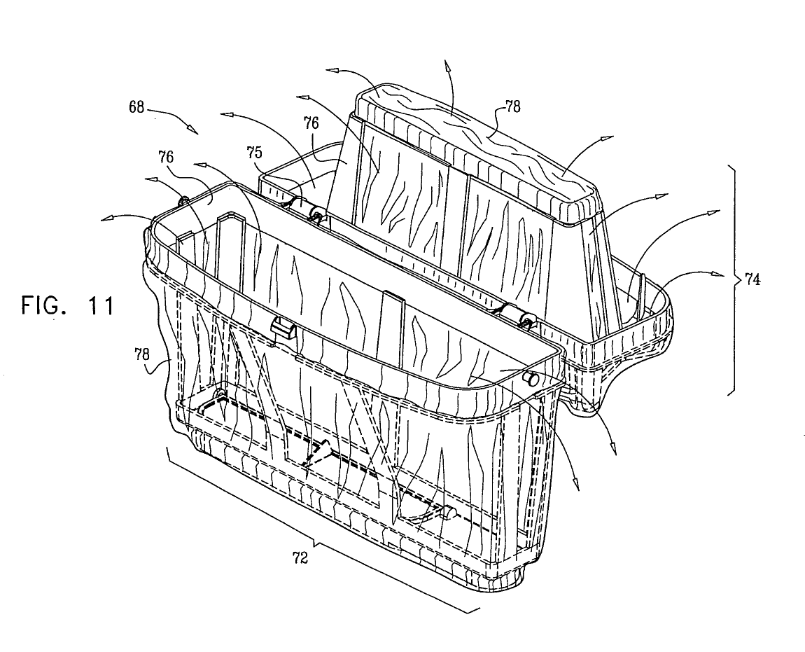

After removal of filter assembly 68 from robot 60, the operator opens the filter assembly, as shown in FIG. 11 (as well as in FIG. 8B), thus gaining access to the interior of the filter assembly. With the filter assembly in this open configuration, the operator is able simply to dump out large contaminants that have accumulated inside the filter assembly, and then to rinse filter material 78 to clean off any remaining contaminants. There is no need to remove the filter material from frame 76 for cleaning. After cleaning, the operator closes lower and upper segments 72 and 74 back together and reassembles the filter assembly into the robot.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Cleaning apparatus, comprising:
a housing, which comprises a lower side comprising an opening, and an upper side comprising an egress port and a lid, which opens to provide access to an interior of the housing;
an impeller, which is disposed within the housing so as to draw water into the housing through the opening and to expel the water through the egress port; and
a filter assembly, which is contained within the housing and is of a size and shape suitable for removal from the housing via the lid, the filter assembly comprising separable upper and lower segments having a wall that comprises a filter material, the lower segment having an ingress port that communicates with the ingress port so that the water drawn in through the opening enters the filter assembly through the ingress port and exits the filter assembly through the filter material.

2. The apparatus according to claim 1, wherein the filter assembly comprises a quick-connect mechanism for holding the upper and lower segments together during operation of the apparatus, whereby contaminants in the water are trapped inside the filter assembly, and for permitting the upper and lower segments to be separated so as to enable an operator to clean the trapped contaminants out of the filter assembly after opening the lid and removing the filter assembly from the housing.

3. The apparatus according to claim 2, wherein the quick-connect mechanism comprises a hinge.

4. The apparatus according to claim 1, wherein the lower side of the housing comprises a plurality of openings, and wherein the filter assembly comprises a plurality of filter assemblies, having respective ingress ports, each of which communicates respectively with one of the openings.

5. The apparatus according to claim 1, wherein the filter assembly comprises a frame, to which the filter material is attached.

6. Cleaning apparatus, comprising:
a housing, which comprises an upper side comprising an egress port and has an open lower side;
an impeller, which is disposed within the housing so as to draw water into the housing through the lower side and to expel the water through the egress port; and
a filter assembly, which comprises:
a cover, which comprises an ingress port, and which has inner and outer sides and is configured to engage and close the open lower side of the housing;
a frame, which comprises a base, which is fixed to the inner side of the cover, and an upper end, which protrudes from the base into an interior of the housing;
a rim, which is sized and shaped to contact the inner side of the cover along a perimeter surrounding the base of the frame; and
a filter comprising a flexible filter material, which has a peripheral edge that is fixed to the rim so that the filter material covers the frame when the rim is in place along the perimeter on the inner side of the cover so that the water drawn in by the impeller enters the filter assembly through the ingress port and exits the filter assembly through the filter material,
wherein the filter material is attached to the upper end of the frame at one or more attachment points.

7. The apparatus according to claim 6, and comprising a catch for holding the cover against the lower side of the housing during operation of the apparatus, whereby contaminants in the water are trapped inside the filter assembly, and for permitting the filter assembly to be removed from the housing so as to enable an operator to turn the filter inside-out for removal of the contaminants by pulling the rim away from the cover and over the upper end of the frame after releasing the catch and removing the filter assembly from the housing.

8. The apparatus according to claim 7, and comprising a handle, which is attached to the rim so as to enable the operator to pull the rim away from the cover and turn the filter inside-out by pulling the handle.

9. A method for cleaning, comprising:
submerging a robot at a bottom of a container of water, the robot containing a filter assembly, which comprises upper and lower segments having a wall that comprises a filter material, the lower segment having an ingress port at a lower side of the robot in communication with the bottom of the container;
operating the submerged robot to draw water in through the ingress port so that the water enters an interior of the filter assembly through the ingress port and exits the filter assembly through the filter material;
following operation of the robot, opening an upper side of the robot, and removing the filter assembly from the robot through the upper side; and
after removing the filter assembly from the robot, separating the upper and lower segments of the filter assembly in order to remove contaminants trapped in the interior of the filter assembly.

10. The method according to claim 9, wherein separating the upper and lower segments comprises releasing a quick-connect mechanism for holding the upper and lower segments together during the operation of the robot.

11. The method according to claim 10, wherein the quick-connect mechanism comprises a hinge.

12. The method according to claim 9, wherein the robot contains a plurality of filter assemblies having respective ingress ports, each of which communicates with the bottom of the container.

13. The method according to claim 9, wherein the filter assembly comprises a frame, to which the filter material is attached.

14. A method for cleaning, comprising:
submerging a robot at a bottom of a container of water, the robot containing a filter assembly, which has an ingress port at a lower side of the robot in communication with the bottom of the container and which comprises a lower cover containing the ingress port, a frame having a base that is attached to the lower cover, and a filter material attached to the frame and having a peripheral edge that surrounds the base;
operating the submerged robot to draw water in through the opening so that the water enters an interior of the filter assembly through the ingress port and exits the filter assembly through the filter material;
following operation of the robot, removing the filter assembly from the robot; and
after removing the filter assembly from the robot, turning the filter material inside-out in order to remove contaminants trapped in the interior of the filter assembly while the filter material remains attached to the frame.

15. The method according to claim 14, wherein the peripheral edge of the filter material is fixed to a rim, which is sized and shaped to contact an inner side of the cover along a perimeter surrounding the base of the frame.

16. The method according to claim 15, wherein turning the filter material inside-out comprises pulling the rim away from the cover and over an upper end of the frame.

17. The method according to claim 16, wherein pulling the rim comprises grasping and pulling a handle, which is attached to the rim.
